(19) United States
(12) Patent Application Publication
(10) Pub. No.: US 2008/0318200 A1
(43) Pub. Date: Dec. 25, 2008

(54) Computer-Aided Method and System for Guided Teaching and Learning

(76) Inventors: Kit King Kitty Hau, Hong Kong (CN); Shi Kin Howard Wan, Hong Kong (CN); Yin Chung Nicholas Wong, Hong Kong (CN)

Correspondence Address: VEDDER PRICE P.C., 222 N. LASALLE STREET, CHICAGO, IL, 60601, US

(21) Appl. No.: 12/090,039

(22) PCT Filed: Oct. 13, 2006
(86) PCT No.: PCT/CN2006/002700

§ 371 Date: May 30, 2008

Related U.S. Application Data
(60) Provisional application No. 60/725,859, filed on Oct. 13, 2005.

(30) Foreign Application Priority Data
Aug. 10, 2006 (US) 11/501974

(51) Int. Cl. G09B 5/00; G09B 7/02

(52) U.S. Cl. 434/362; 434/327

(57) ABSTRACT

The present invention is a computer aided method and system for guided teaching and learning with the aid of an optional communication device, comprising the steps of: (a) presenting a question to the student at a student display; (b) receiving answer from the teacher at the teacher workstation, wherein the answer is received by the teacher from the student or directly from the students remotely; (c) sharing the answer submitted on at least one student displayed) determining whether the answer is correct; (e) presenting feedback to the answer at all student displays or workstations; (f) receiving input from the teacher at the teacher workstation for the teacher to give further information related to the question on student display; and (g) presenting information using a plurality of styles and stimuli corresponding to the input from the teacher or student on the student display.

### TECHNICAL FIELD

The present invention relates generally to a computer-aided method for teaching and training, and a system to implement such method. In particular, the present invention relates to guided teaching in, for example, teaching a language to non-native speakers of the language, which combines the guidance of a teacher and the teaching materials presented in an interactive, audio-visual manner.

### BACKGROUND

As the new generation is exposed to using computer as a communication means, instant messaging software is popular among students as a communication outside the classroom. Students are also used to the audio-visual stimulation common in most video games. Many automated teaching systems adopting a computer game format have been created in order to replace the conventional classroom method and to make learning a more attractive and enjoyable experience to students.

In teaching language, for example, a teaching approach is for the student to do exercises related to the words to be taught. The student may be asked to give a definition of a word, fill a word in a blank part of a passage, or to identify a picture related to a specific word, while a number of answers are given for the student to choose from. There are existing software packed with graphics and sound effects using such approach to enhance learning effectiveness that may be able to arouse the students' interest in doing the exercise. However, the value of those software can be doubtful if appropriate guidance in reaching the correct answer sensibly is not provided, as the student who may simply make wild guesses and be frustrated by repeatedly failed attempts to arrive at the right answer, thus losing motivation to participate as a whole.

Obviously, the main disadvantage of such automated teaching method is that it lacks the human touch and the guidance from a teacher, which are the crucial elements that these products have thus far failed to capture from the conventional teaching method. The guidance of a teacher serves to guide the student back on the right track to think sensibly when a wrong answer is selected by leading the student through a brainstorming process, using additional data or hint that can assist the student to reach the correct answer in a sensible manner but not by wild guessing that very often is merely the effect of reflexive sense. Such discussion creates a bond between teacher and student and forms a friendly, appealing and interactive learning atmosphere which is only found in conventional classroom approach.

There are drawbacks however in conventional classroom approach that has to be refined using modern technology. The major one perhaps is the pre-requisite for the teacher to be very proficient in all aspects of the subject matter. Due to the complexity of some subjects such as language, it very often takes exhaustive training to groom high caliber teachers who shall have a strong grasp of grammar as well as the intuition for application of the language. Hence, it makes sense to have a system that can equip the teacher with preloaded data and answer keys to support his teaching, with which the teacher is able to gradually pick up more knowledge about a particular subject matter as he uses the system to teach repeatedly along. That way, teacher can focus on playing the role as a facilitator to guide the students through an interactive learning process, and be released from the cumbersome task of digesting the details before giving the lesson.

Moreover, globalization has called for increased international communication. A few languages, such as English and Mandarin, are becoming more popularly used around the world, which in turn leads to an increase in the demand of language teachers to teach non-native speakers. A user-friendly teaching system is required to reduce the training period of the teachers. Undoubtedly, the value of a system with pre-loaded data is especially outstanding in situation where supply of experienced teachers or trainers is limited.

Another advantage of a preloaded database is that it can upkeep a curriculum systematically that can be then delivered in a method preset by the system, avoiding the subject matter and additional hint delivered by one teacher to deviate much from another. In addition, when a teacher departs or is absent, substitute teachers can readily assume his role using the same system loaded with teaching material to be delivered in manner already adapted by the students.

As it is rather time consuming to gather information and statistics on classroom experience for refining curriculum, a good system shall allow storing valuable information generated by teachers and students in the classroom for the purpose. In addition, flexibility for sharing the same among different teachers and students should be emphasized. The teacher himself may sometimes have much insight to offer in teaching a particular subject matter. The same situation applies to students too. In teaching vocabulary, for example, a student may have created a sentence to demonstrate the use of a word that is worth sharing with the students in other classes, on the other hand, may have misunderstood the usage of another word that can be applied as teaching material so that the other students can learn from sharing such mistake. One can imagine how many creative examples of vocabulary application and teaching ideas have gone down the drain due to the inability of educational systems to capture and share them amongst the teachers and students. In other words, an effective teaching system should not only restrict learning from the input of the teacher and the students in one class, but should also facilitate the sharing of such input in an larger scale, covering classes taking the same course within a school using the same LAN, or even other schools conducting classes using the same WAN.

There are difficulties though in sharing teaching content and method of teaching between classes that need to be addressed too—Due to also the effects of globalization and the impact of modern technologies, it is not uncommon nowadays for people of different cultural backgrounds and language abilities to learn under one roof or remotely apart. Therefore, there should be a system that can support cross cultural teaching and learning to allow students to learn together and progress at individual pace without affecting his peers too much.

Another essential feature needed of a system with preloaded curriculum is that it should be able to handle the large amount of input from different sources by identifying what should and should not be stored. There should be a resource effective component to ensure that the data so stored is of quality and that it is easily accessible to the users concerned.

No matter how well a teaching and learning process is designed and how experienced the teacher is in applying the process to teach, students may fail to perform the way they should in light of the many distractions facing them. Hence, a good system should be equipped with a control to appraise effectiveness and most importantly suggest remedial action accordingly.

To ensure teaching effectiveness, very often educators or trainers need to give extra support to the slower performers. There should be a system that allows and structures tutorial sessions to be carried out by a peer teacher or student taking the role of the original teacher in similar manner as the original lesson has been taught. Although the teacher may select manually the students he believes to be weaker in performance and those stronger ones to be the buddy teacher, it will spare the teacher from such cumbersome process if the system can also automatically identify student tutors, the participating students and most importantly, to structure the appropriate teaching contents to be used in the relevant extra tutorial session.

Last but not least, although in class face-to-face teaching is a preferred method of implementation, a good system shall acknowledge distant learning being a solution for educators and trainers in times of technical problems such as bad weather, war or wide spread epidemics etc. or where expertise about a particular subject matter cannot be made available simultaneously at different classrooms located apart. Therefore, the system should cater for different implementation methods, allowing at least one student and or one teacher/trainer leading a class of student(s)/trainees located remotely away from the more experienced teacher(s) to take part

The invention is a computer aided method and system that effectively apply information technologies to turn teaching and learning process into a fun-filled interactive logical guessing game, which can address the above educational problems by incorporating scientific education management methodologies into teaching and learning.

### SUMMARY OF THE INVENTION

The object of the present invention is to provide a computer-aided method for guided teaching, wherein teaching materials of various styles and stimuli are used.

In accordance with the present invention, there is provided a computer aided method for guided teaching and learning, using vocabulary as an example of subject matter. There are at least two methods of implementation. Implementation Method (1) for at least one teacher and one student within the same LAN, using at least one teacher workstation, with at least one student workstation, using at least one central processing unit, as well as an optional network or delivery device to support multimedia transmission of classroom discussions if needed. Implementation Method (2) for at least one teacher and one student or group of students on the WAN, using at least one central processing unit, as well as an optional network or communication to support multimedia transmission of classroom discussions if needed. The computer aided method and system comprising the steps of

In Implementation Method (1):
(a) presenting a question that is the subject item to the student at a student display;
(b) receiving answer from the teacher at the teacher workstation, wherein the answer is received by the teacher from the student or students in class;
(c) sharing the answer submitted on at least one student display;
(d) determining whether the answer is correct;
(e) presenting feedback to the answer at all student displays or workstations;
(f) receiving input from the teacher at the teacher workstation for the teacher to give further information related to the question on student display;
(g) presenting information sequentially and structurally using at least one of a plurality of styles and stimuli corresponding to the input from the teacher or student on the student display;

In Implementation Method (2):
(a) presenting a question that is the subject item at a teacher or student display;
(b) allowing the teacher(s) and student(s) located apart to communicate interactively using separate device(s);
(c) receiving answer from a remote teacher using a workstation whereas the answer is received by the remote teacher from the student or students in class; or receiving answer submitted directly by a remote student using a workstation;
(d) sharing the answer submitted by the remote teacher or student on other displays or workstations connected together on the same WAN;
(e) determining by the system whether the answer is correct;
(f) presenting feedback by the system instantly to the answer submitted at all remote displays or workstations;
(g) receiving input from the teacher at the teacher workstation for the teacher to give further information related to the question on student display;
(h) presenting information sequentially and structurally using at least one of a plurality of styles and stimuli corresponding to the input from the teacher or student on the student display;

The present invention provides significant advantages over the conventional teaching method, for example, the teacher may provide guidance to the student on the student display or on remote workstation connected to the teacher's workstation, using various styles and stimuli, such as text, sound, voice, audio, graphics, pictures, photographs, animation, comics or video, in a guided teaching approach. Such guidance is applicable in many teaching modes and is especially effective when the teacher uses multiple choice questions to interact with the students in the teaching process. The students will not be frustrated after selecting a wrong answer because the teacher, with the aid of the system, can guide the student to reach the correct answer afterwards.

In one embodiment of the present invention, after presenting the question to the student on the student display, the teacher may present additional information related to the question on the student display to guide the student to reach the right answer.

In another embodiment of the present invention, the teacher is provided, on his teacher display, with the necessary information for guiding the student(s) to learn, including the correct answer to the question he present to the student for teaching.

In another embodiment of the present invention, the additional information may be presented in a plurality of styles and stimuli, comprising: text, sound, voice, audio, graphics, pictures, photographs, animation, comics or video to arouse the interests of the student to learn.

In another embodiment of the present invention, the teacher may save and share teacher notes with other teachers on the same LAN or WAN.

In another embodiment of the present invention, the student may save and share notes with other workstations on the same LAN or WAN.

In another embodiment of the present invention, the teacher notes shared among teachers on the same LAN or WAN may be presented in a plurality of styles and stimuli, comprising: text, sound, voice, audio, graphics, pictures, photographs, animation, comics or video.

In another embodiment of the present invention, the student notes shared among teachers on the same LAN or WAN may be presented in a plurality of styles and stimuli, comprising: text, sound, voice, audio, graphics, pictures, photographs, animation, comics or video.

In another embodiment of the present invention, the system saves and shares notes submitted by teachers and students systematically.

In another embodiment of the present invention, the teacher is provided with a feature to retrieve flexibility the saved notes authorized to be shared.

In another embodiment of the present invention, a system is provided to ensure the teaching materials and hints delivered to the students by various teachers either located physically in the same class with the students or remotely away from the students are consistent.

In another embodiment of the present invention, the teacher may adjust the teaching materials pre-set in the system.

In another embodiment of the present invention, a system is provided to automatically formulate the level of difficulty of the questions and teaching mode applicable presented to the students according to the performance of the students.

In another embodiment of the present invention, the teacher is provided with a feature to dynamically re-formulate the level of difficulty of the questions and teaching mode at his discretion.

In another embodiment of the present invention, a system is provided to allow another person, for example, a replacement teacher or a student, to take up the role of the original teacher without much deviation from the original teaching style.

In another embodiment of the present invention, a system is provided to assign the appropriate students to conduct or to take extra tutorial session, whereby to appoint at least one students if needed who is qualified for taking the role of the teacher in the same manner as the original lesson has been conducted.

In another embodiment of the present invention, a system is provided to adaptively formulate the teaching content of the extra tutorial session based on the attendance record and performance of the students assigned to take the extra tutorial session.

In another embodiment of the present invention, a system is provided for the teacher to re-formulate the teaching content of the extra tutorial session based on the attendance record and performance of the students assigned to take the extra tutorial session.

In another embodiment of the present invention, the key information taken down by the system or provided by different teachers and students joining the same teaching process is recorded by the system for future review of the course materials.

In another embodiment of the present invention, the system provides extra means of communication to allow sharing of such interactive guided teaching and learning process with other remote venues simultaneously using a cascade remote network or other device(s) to support conference meeting between the teacher(s) and student(s).

In another embodiment of the present invention, the system identifies automatically the quality of the teacher and student notes and processes the notes to make it easily accessible to teachers and students.

### BRIEF DESCRIPTION OF DRAWINGS

The above and other aspects, features, and advantages of the present invention will become more apparent upon consideration of the following detailed description of the preferred embodiments, taken in conjunction with the accompanying drawing figures, wherein:—

FIG. 1 is a flowchart which illustrates the log-in process in accordance with an embodiment of the present invention;

FIG. 2 is a flowchart which illustrates the retrieval of teaching materials in accordance with an embodiment of the present invention;

FIGS. 3a-3c are a set of flowcharts which illustrates the process of the guided teaching and learning method in accordance with an embodiment of the present invention;

FIG. 4a shows the screen capture on the teacher workstation in accordance with an embodiment of the present invention to illustrate teaching, controlling the display of data on student's display or workstations, capturing and sharing input from teachers and students, displaying more data or hints using different stimuli and extra language translation support, adjusting level of difficulty by the teachers dynamically.

FIGS. 4b and 4c show the screen capture on the student display in accordance with an embodiment of the present invention;

FIG. 4d shows the screen capture in accordance with an embodiment of the present invention to illustrate how the teacher prepares in advance teaching notes and pre-selects from database materials shared by other teachers and students for supporting teaching. The materials shared may be presented in various styles and stimuli, such as text, sound, voice, audio, graphics, pictures, photographs, animation, comics or video;

FIG. 4e show the screen capture on the teacher or student workstation in accordance with an embodiment of the present invention to illustrate the student workstation used in distant learning;

FIG. 5a shows the screen capture on the teacher workstation in accordance with an embodiment of the present invention to illustrate teaching, controlling display of data on student's display or workstations, capturing and sharing input from teachers and students, displaying more data using different stimuli and extra language support, adjusting level of difficulty by the teachers dynamically;

FIG. 5b shows the screen capture on the student display in accordance with an embodiment of the present invention;

FIG. 5c shows the screen capture on the student display in accordance with an embodiment of the present invention;

FIG. 5d shows the screen capture in accordance with an embodiment of the present invention to illustrate how the teacher prepares teaching notes and pre-selects from database the materials shared by other teachers and students for supporting teaching;

FIG. 5e show the screen capture on the teacher or student workstation in accordance with an embodiment of the present invention to illustrate the teacher or student workstation used in distant learning;

FIG. 6 illustrates a network arrangement in accordance with an embodiment of the present invention;

FIG. 7 is a flowchart which illustrates an individual practice session in accordance with an embodiment of the present invention;

FIG. 8 shows the screen capture which illustrates the recording of the score of students or trainees in the individual practice session in accordance with an embodiment of the present invention;

FIG. 9 is a flowchart which illustrates the adaptive teaching in accordance with an embodiment of the present invention;

FIG. 10 is a Remote teaching network diagram illustrating the method of implementation of the guided teaching and learning method on LAN;

FIG. 11 is a user interface of video conference between at least one teacher and one student on LAN;

FIG. 12 is a cascade remote teaching network diagram illustrating the method of implementation of the guided teaching and learning method on WAN;

FIG. 13 is a user interface of video conference between at least one teacher and one student on WAN.

### DETAILED DESCRIPTION OF THE INVENTION

### Log-In

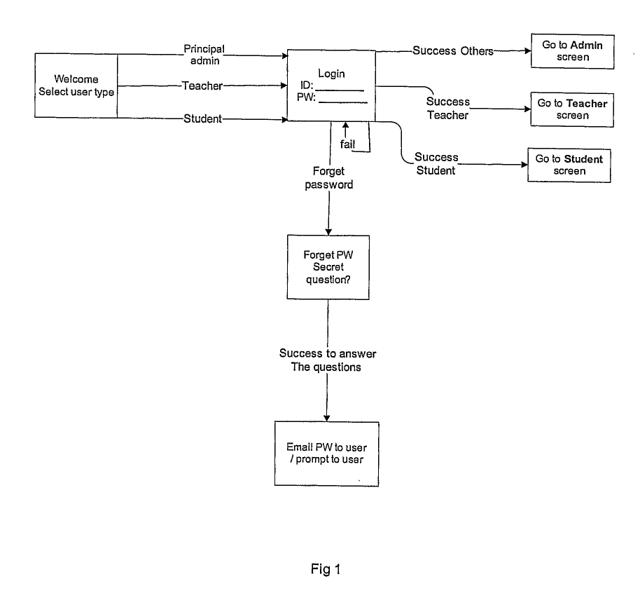

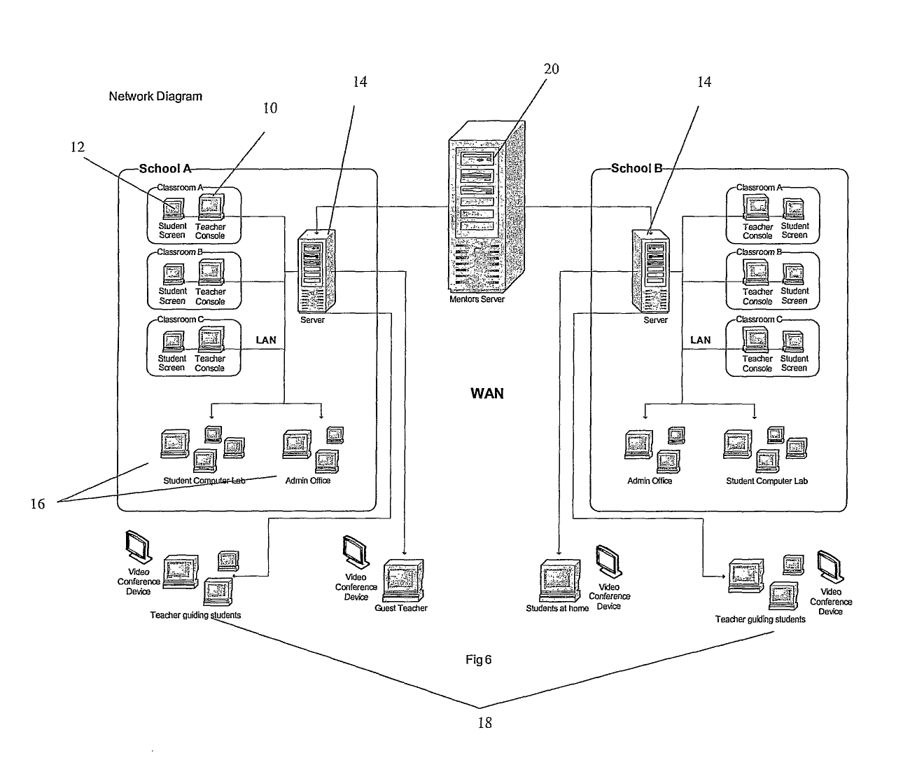

As illustrated in FIGS. 1 and 6, a preferred embodiment of the present invention allows the teacher to log-in at a teacher workstation [10] to record the teacher's attendance for a guided teaching session. The teacher, as well as the remote teacher(s) in the case of distant learning, may also log-in the students who are present for the student attendance record. Once the teacher logs in, he is provided with the option to trigger additional communication devices, for example, video conference system, to support interactive teaching and learning. The teacher workstation [10] may, for example, be a notebook computer or a terminal, with a display device and a keyboard.

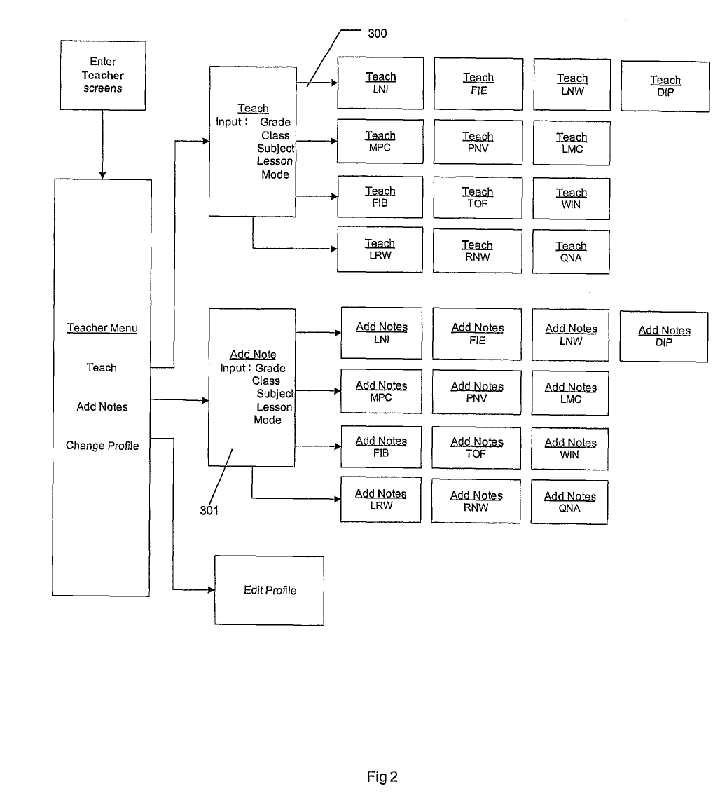

As illustrated in FIG. 2, in step [300], the teacher inputs the information related to the guided teaching session, for example, the grade, the class, the subject, as well as the lesson that can retrieve the relevant teaching mode and the pre-loaded teaching materials. The teaching mode defines the type of question used in the teaching and learning e.g. English, to be presented to the students. Some examples of the teaching mode are:

| Teaching mode | Description of question type |
|---|---|
| LNI | Listen to the description and identify a related |
| | picture, video, picture, or other subject matters |
| LNW | Look at an object and write |
| MPC | Multiple choice |
| FIE | Fill in the essay |
| LMC | Listen to Mandarin or another language and choose an |
| | answer in English |
| FIB | Fill in the blank |
| TOF | True or false |
| LRW | Link the right word |
| RNW | Read and write |
| WIN | Arrange pictures, video or subject matters in a logical |
| | manner based on hints given |
| QNA | Question and answer |
| DIP | Definition of idiomatic phrase |
| PNV | Passage and vocabulary |

Various teaching modes are provided so that the same set of materials used in teaching a language can be applied in different teaching modes according to the level of students and the desired outcome.

### A Preferred Embodiment Dip Mode

A preferred embodiment for teaching idiomatic English, also known as phrasal verbs in a guided teaching session, is used to illustrate the present invention. A phrasal verb contains a verb and a preposition, which carries a specific meaning only when the two parts are combined and used together.

Regardless of the subject matter and the teaching mode chosen, the guided teaching session may be divided into the following major steps:

1. Show and ask;

2. Show more and prompt;

3. Show and challenge; and

4. Show and instruct

### 1. Show and Ask

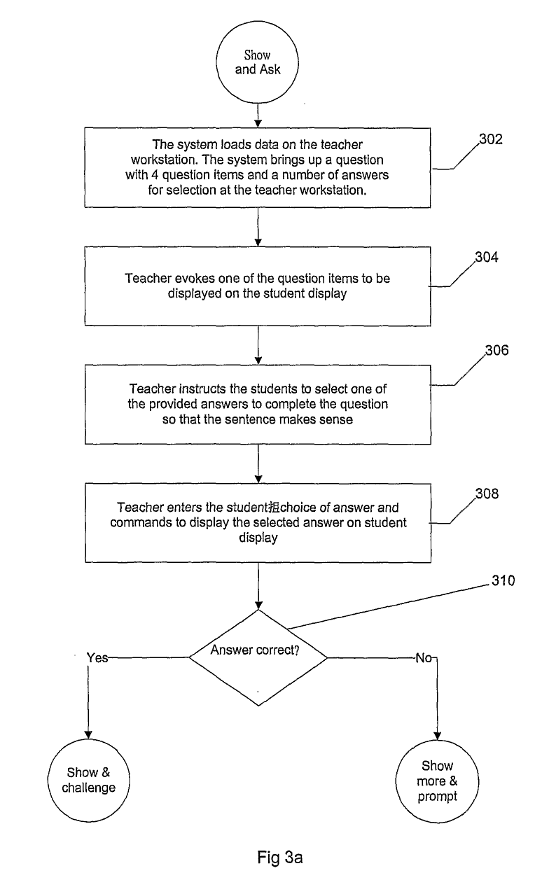

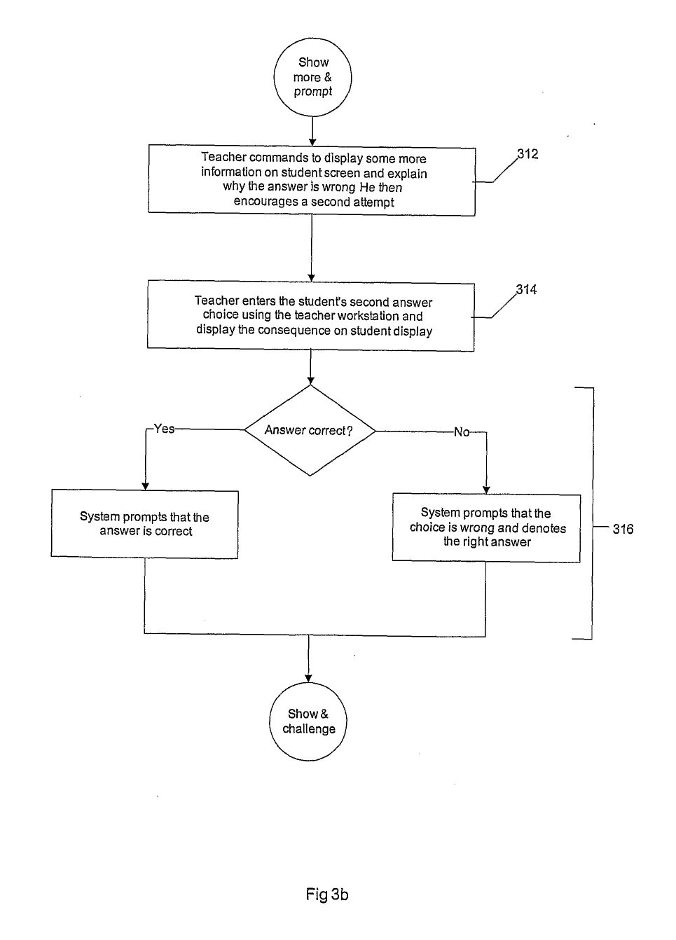

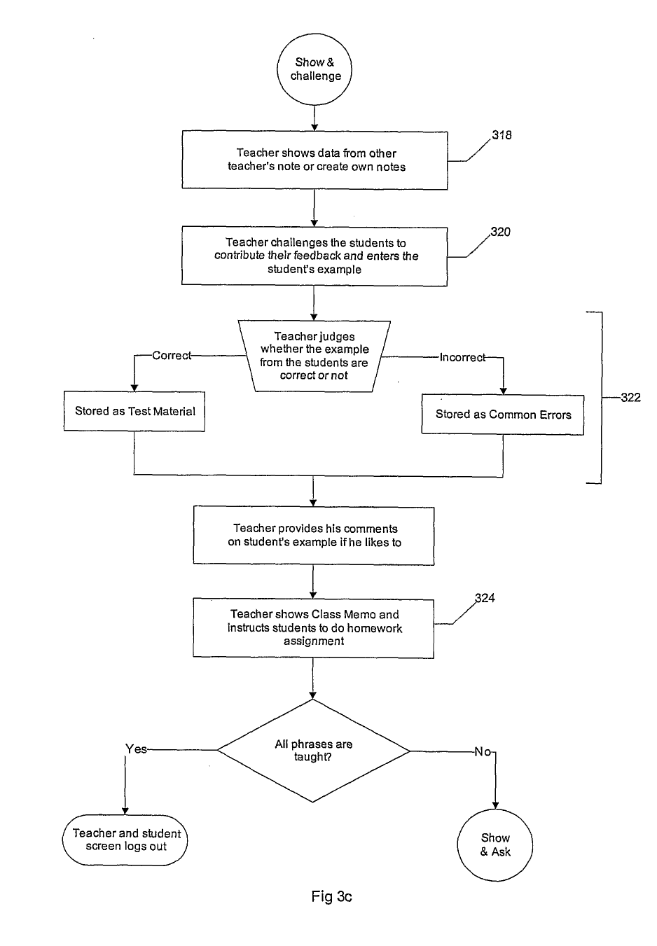

In a preferred embodiment, as illustrated in FIGS. 3a, 4a and 6, in step [302], a question set [110] containing a set of question items and a number of answers [112a] for selection is displayed at the teacher workstation [10]. The question set [110] is a number of question items being sentences each containing a verb and a following blank for student to insert an appropriate preposition. The students are given a list of answers [112a] to select from. In step [304], the teacher selects a question item among the question set [110] to work on and to be presented on a student display [12]. By way of example, the question item [114a] is selected.

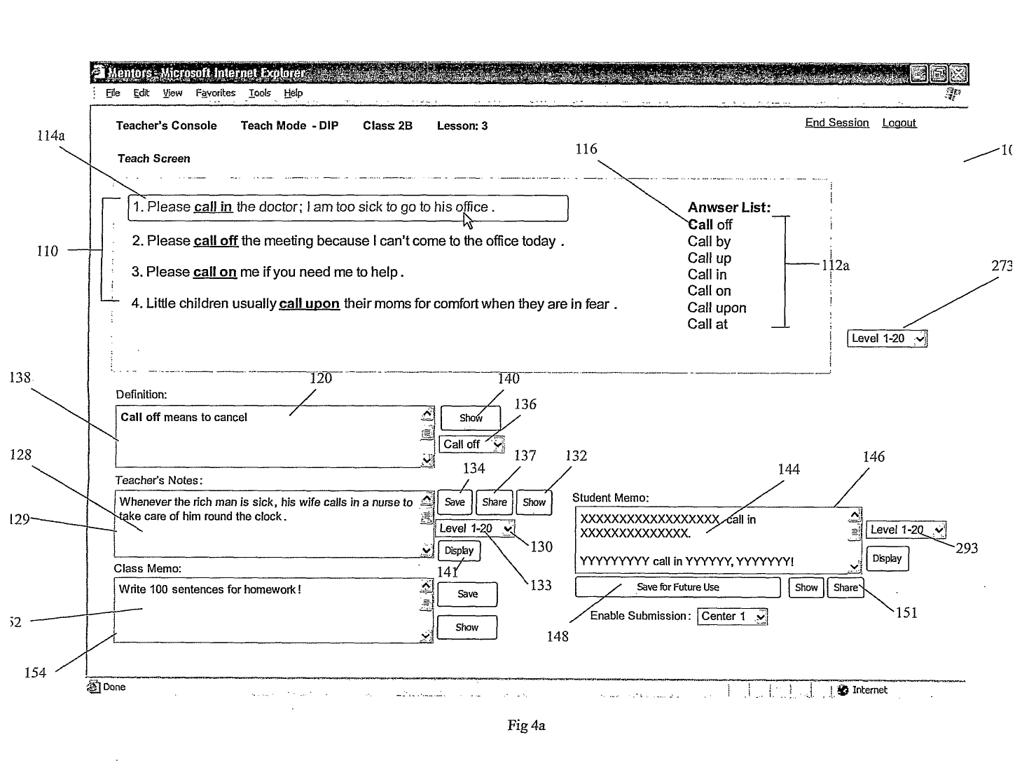

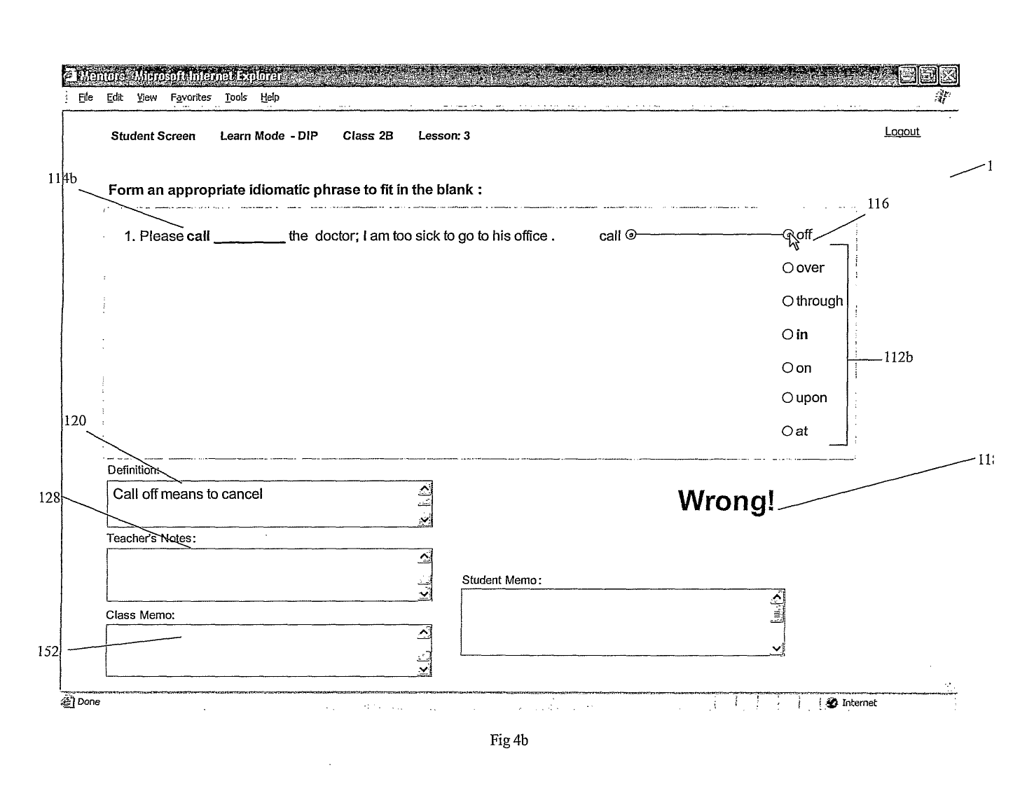

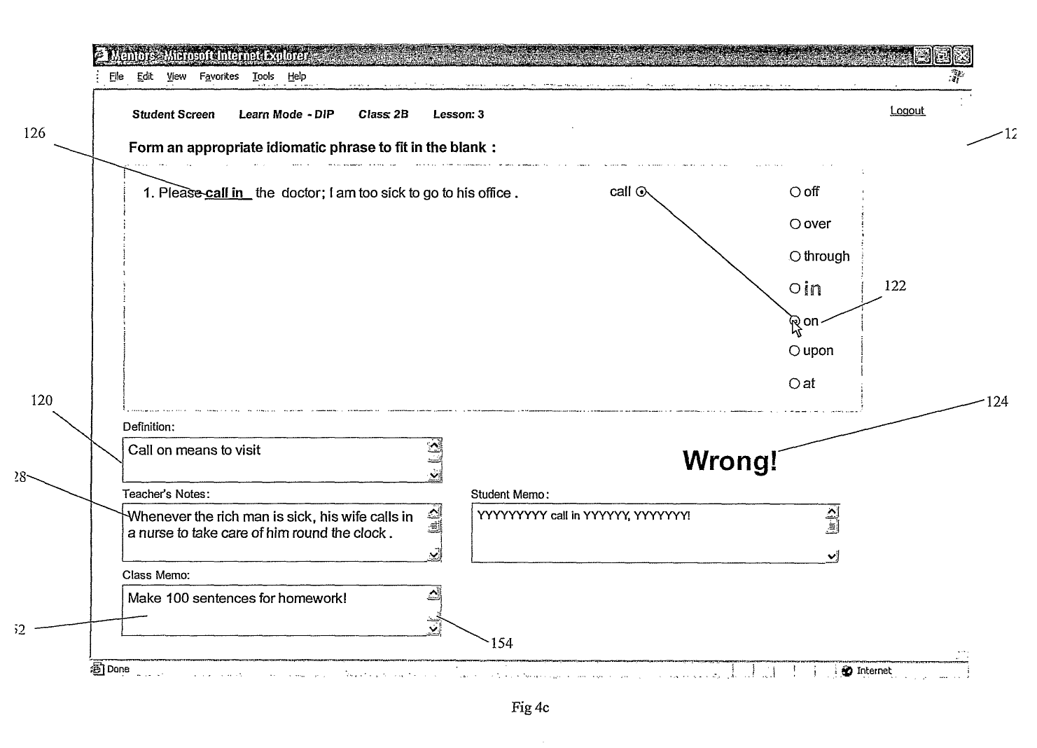

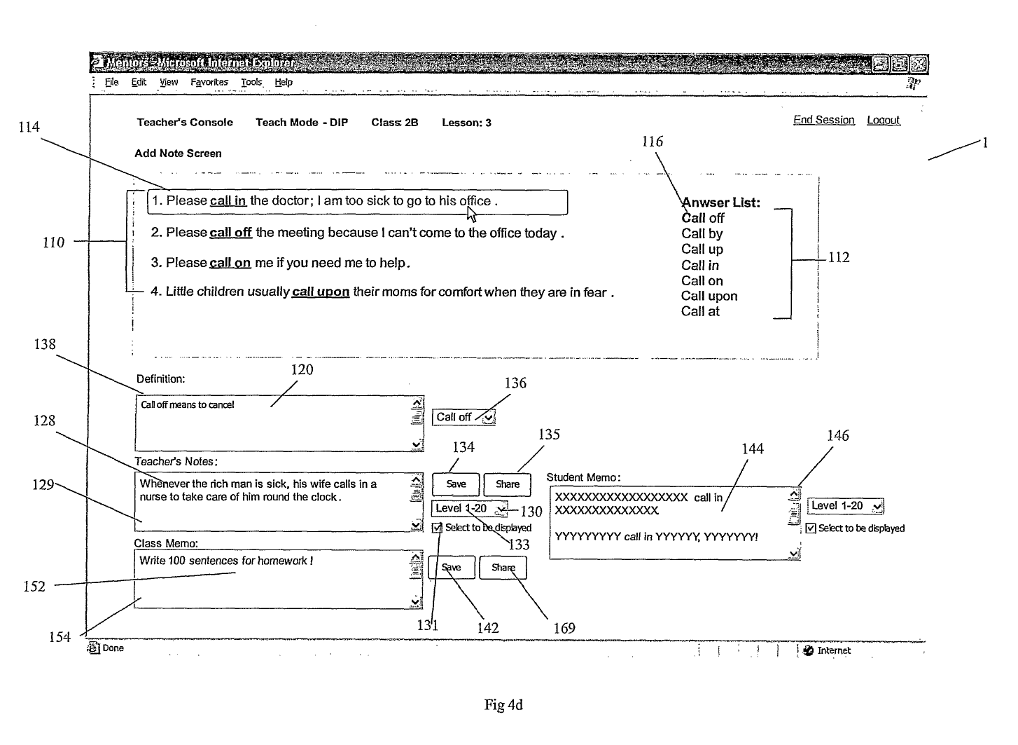

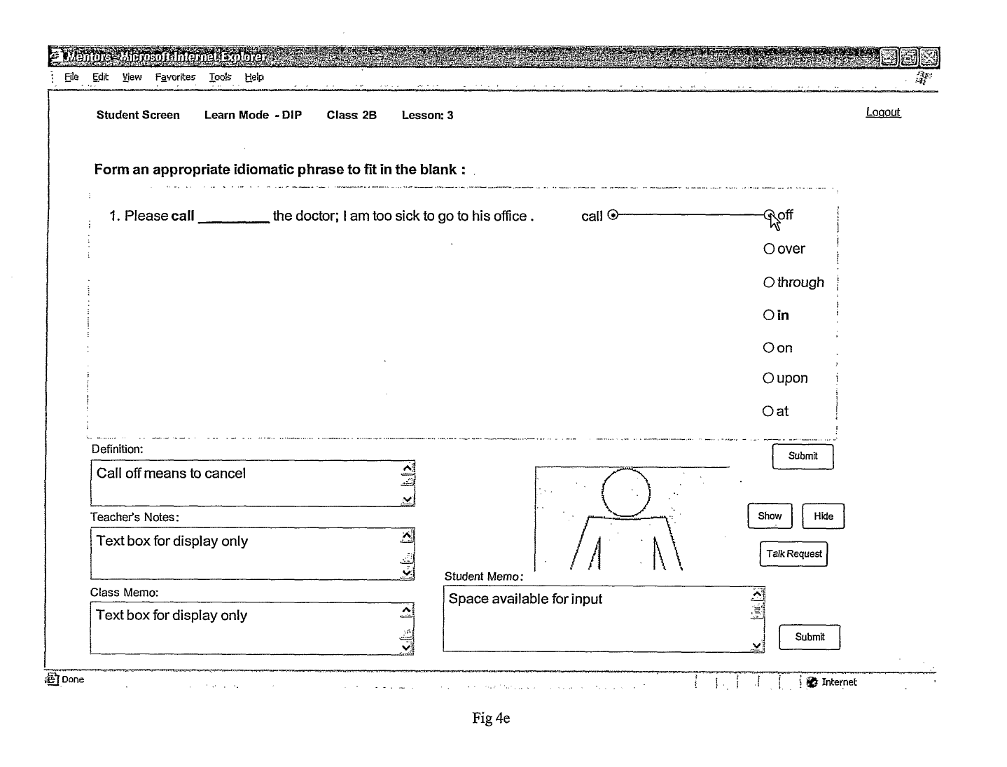

The student display [12] may, for example, be a projector and screen for displaying to the whole class of students, or an individual monitor for each student. FIG. 4b shows the screen displaying the question item [114b] selected by the teacher and the answers [112b] available for selection.

In step [306], the teacher discusses and interacts with the students until he has obtained one answer from the students to be entered. In step [308], the teacher clicks on the answer [116] selected by the students on the teacher workstation [10].

The answer [116] selected by the student will be shown on the student display [12]. In this preferred embodiment, a line is connected from the relevant verb to the selected preposition [116] to show the students the selected answer.

In step [310], a central processing unit [14] performs the comparison of the selected answer [116] with the correct answer. A feedback [118] is displayed on the student display [12]. The feedback [118] may be in the form of text, graphics or animation combined with sound effect, for indicating whether the selected answer [116] is correct or not.

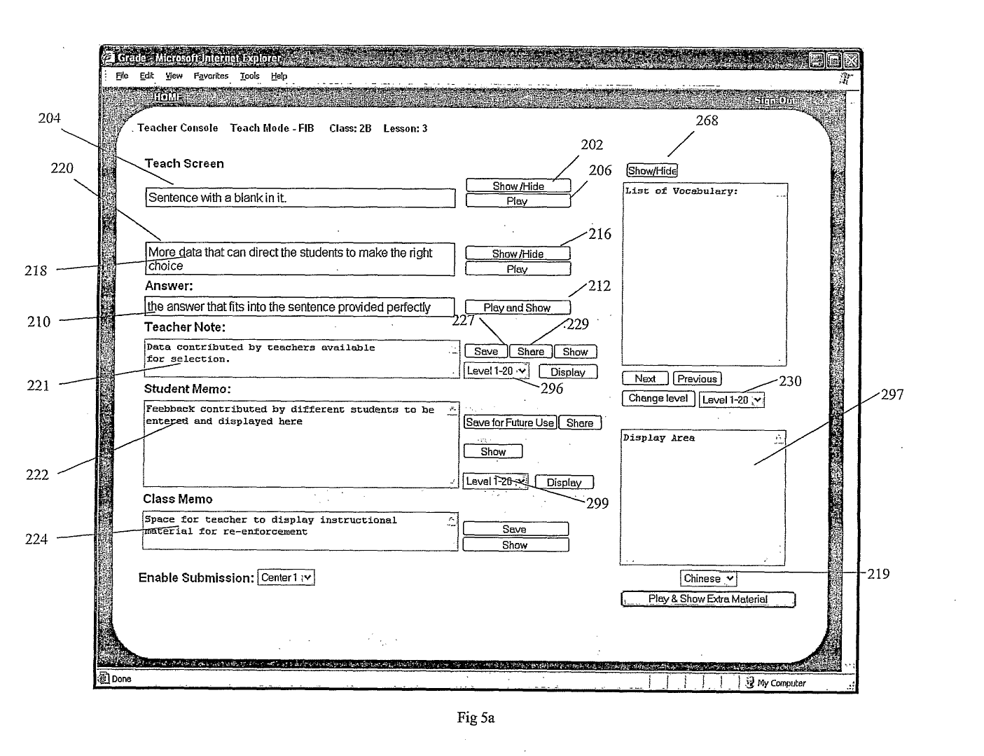

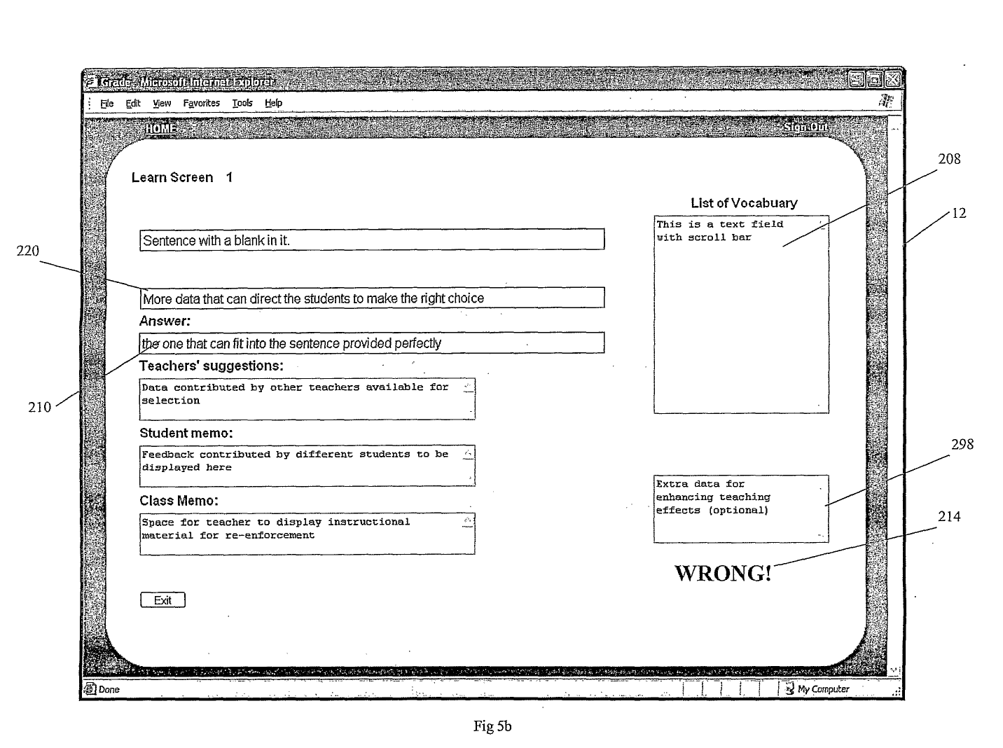

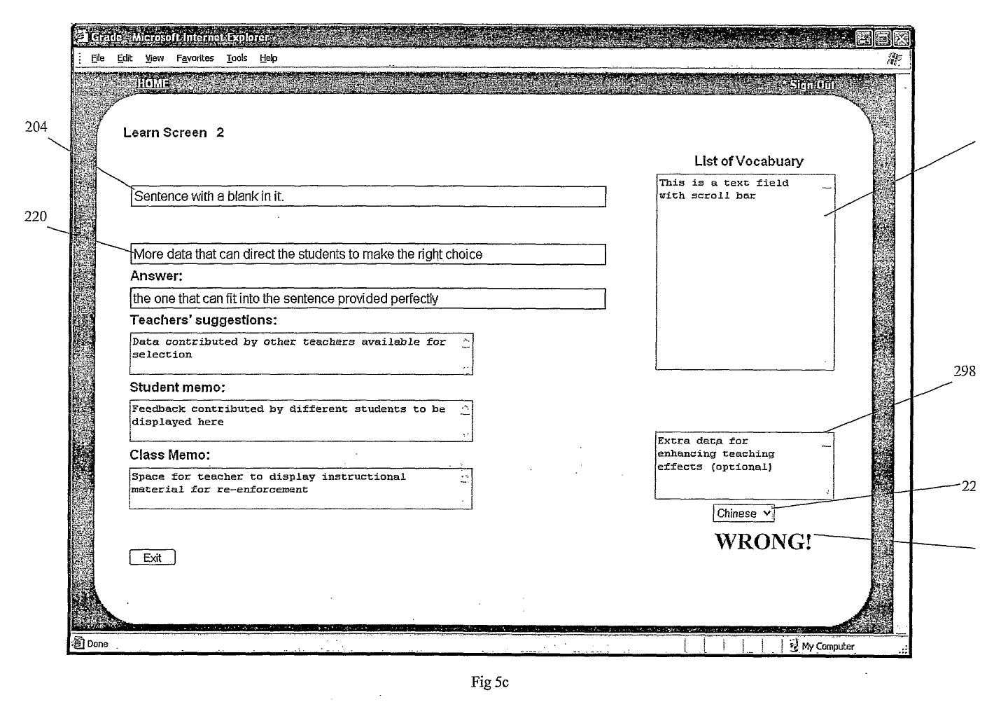

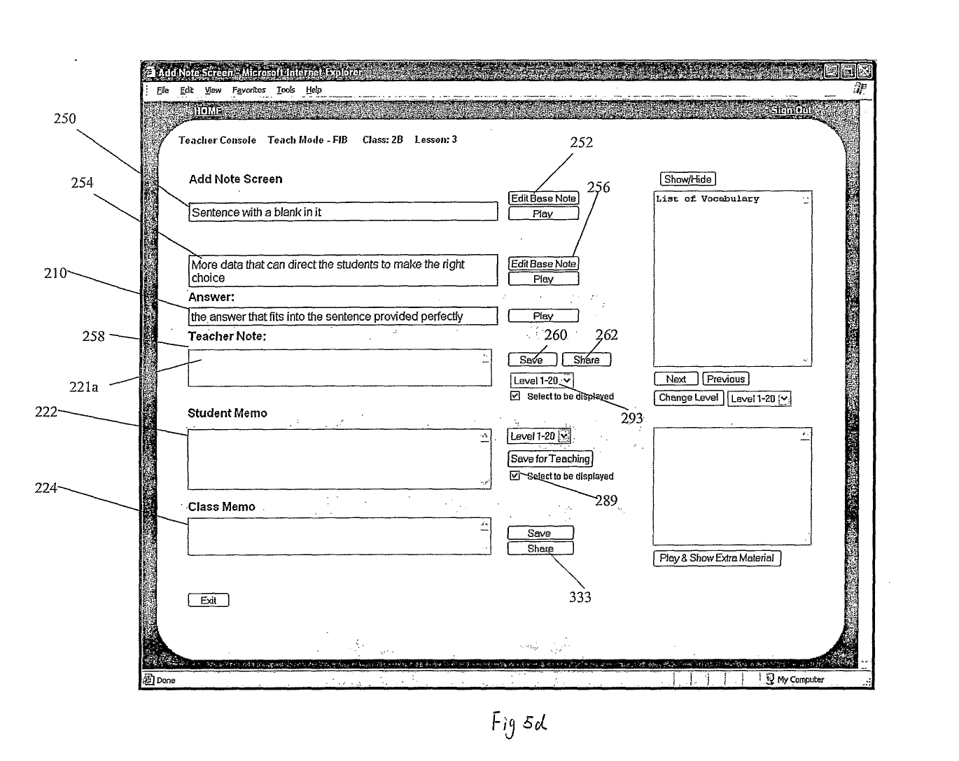

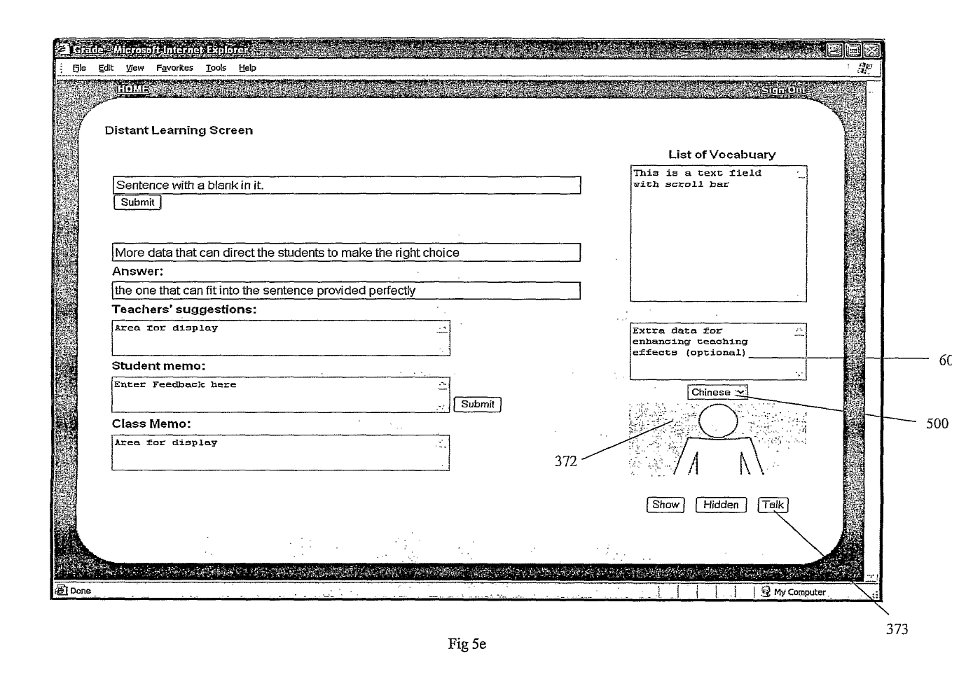

When the guided teaching and learning process is conducted remotely, the host teacher can use a screen similar to teacher screen [FIG. 4a] and [FIG. 5a] to allow the remote teacher using button [114a] on FIG. 4a or [204] on FIG. 5a to input answer to the question present on the all the student displays, whereas the answer is collected by the teacher from his student(s). Meanwhile, the optional communication in the form of, for example, video conference serves to support interactive discussions.

### 2. Show More and Prompt

As illustrated in FIGS. 3b, 4a and 4b, in step [312], if the selected answer [116] is wrong, the teacher may explain why the answer is wrong to the students by giving further information [120] related to the question [114b]. The information [120] is provided to guide the students to have a second attempt to get to the correct answer, which can be in the form of various styles and stimuli, such as text, sound, voice, audio, graphics, pictures, photographs, comics, video, or a combination of the above, to make the teaching process more appealing to the students.

By way of example, the information [120] is the definitions of the phrasal verbs given as the answers [112b] in text form. The teacher may select the phrasal verb of which the definition is to be shown from box [136] at the teacher workstation [10].

The information [120] is shown in box [138] on the teacher workstation [10]. The teacher may click Show button [140] to display the information [120] at the student display [12]. By way of example, the information [120] may also be provided in an audio form, that is, by executing an audio file containing the syllabus of the definition.

Such audio file may also contain a version in the native language of the student to enable the student to understand the information [120] more easily. The teacher may present the definitions of some or all the phrasal verbs in the answers [112a] one by one by clicking to select on [136]. After learning the definitions of the phrasal verbs, the students can easily select the right answer. The provision of the information [120] allows the students to make an educated selection rather than a wild guess.

As illustrated in FIG. 4c, in step [314], the teacher leads a brainstorming discussion with the students to obtain an answer [122] from the students and inputs the answer at the teacher workstation [10]. The student display [12] shows the answer [122] and the feedback [124]. The teacher may choose to present the correct answer [126] as shown in step [316] or to repeat step [312] to give further information [120] to the students.

### 3. Show and Challenge

As illustrated in FIGS. 3c, 4a and 4c, after displaying the correct answer [126], in step [318], the teacher may review his or other teachers' teaching notes [128] with respect to the question set [110], stored in the central processing unit [14] by selecting a level indicator [133] using pull down list [130]. The teaching notes [128] may be examples created by the teacher (see Review before class below) or used by other teachers to illustrate the correct answer [126]. The teaching notes [128] are grouped with respect to each specific question set and are automatically assigned a level indicator [133] on the level of difficulty according to the class for which the teacher has saved the teaching notes [128] for. By clicking the “Display” button [141], the teaching notes [128] stored in the system may be shown at the student display [12].

The teacher may also create his own teaching notes [128] in class in box [129] and show the teaching notes [128] at the student display [12] by clicking the Show button [132]. The teaching notes [128] will be saved for future reference. The teacher may save the teaching notes [128] without showing on the student display [12] by clicking the Save button [134]. If the teacher wants to make the teaching notes [128] available for other teachers, he may click the Share button [137] to authorize the sharing.

In step [320], the teacher guides the students to create their own sentences using the phrasal verb taught in the question [114a]. The teacher may enter the sentences [144] created by the students as reference notes in box [146] at the teacher workstation [10].

In step [322], the teacher may discuss with the students about the created sentence [144] and give his comments. If the created sentence [144] is a good example of the use of the phrasal verb, the teacher may save the sentence for future use by clicking the button [148]. If the created sentence [144] seems to be a common error made by many students, the teacher may save the sentence for future teaching purpose. If the teacher wants to make the sentences [144] available for other teachers, he may click the Share button [151] to authorize the sharing too.

### 4. Show and Instruct

The teacher may proceed to the next question by repeating from step [304]. In the course of teaching, the teacher may provide instructions to the students on homework assignments. In step [324], the teacher may enter the instructions [152] in box [154] at the teacher workstation [10] and click Show button to show the instructions [152] on the student display [12].

### Review Before Class

As shown in FIG. 4d, the teacher may preview the teaching materials, for example the question set [110] and the answers [112] for selection before conducting the teaching session. The teacher can therefore become acquainted with the teaching materials before class.

The teacher may also create some examples of sentences or other stimuli to illustrate the correct answer. Such examples or stimuli may be saved as teaching notes [128] in box [129] by clicking Save button [134] for the teacher's own retrieval or by clicking Share button [135] for sharing with other teachers. The teaching notes [128] are saved with respect to each question set and are assigned a level indicator [133] according to the level of the class the teaching notes [128] has been created for. The teacher may also review the teaching notes [128] of other teachers by selecting the level indicator [133] at box [130]. The teacher may pre-select the teaching notes [128] or stimuli of the teachers to be shown in the class by checking the box [131]. The pre-selected teaching notes or stimuli may be recalled in class by clicking Display button [141] as shown in FIG. 4a.

In order to facilitate the teacher in shuffling and viewing the saved teaching notes or stimuli of other teachers', the central processing unit [14] may keep track of the number of times the teaching notes or stimuli have been selected to show to the students, and automatically delete the teaching notes below a predetermined selection rate in a period of time.

The teacher may also save some instructions [152] to be presented in class to students by inputting in box [154] and clicking Save button [142]. He may also share the instructions with other teachers by clicking Share button [169].

### Another Embodiment

### FIB Mode

In addition to the above embodiment for teaching phrasal verbs, the present invention is also applicable in other teaching mode. In another preferred embodiment for teaching vocabulary, the present invention is used in providing fill-in-the-blank questions using the FIB mode. The students are given a selection of words, which usually carry clear meanings by themselves. The teacher is allowed to provide additional hint or information to the students for reaching the correct answer.

As illustrated in FIGS. 5a and 5b, the teacher may click button “Show/Hide”[202] to present the question at a box [204] on the student display [12]. The teacher may also click button “Play”[206] to play a pre-recorded audio form of the question. A list of answers containing one correct answer is provided in box [208] on the student display [12]. The teacher may choose to hide the list of answers by clicking button [268] to create bigger challenge. The teacher may enter an answer in the blank in [204], which is collected from the students. A box [214] will show whether the answer entered is correct. If the answer is wrong, the teacher may further click the “Show/Hide” button [216] to show the additional information [218] on the student display [12] in box [220] which will assist the students in reaching the correct answer. By way of example, the information may be the definition of a word in box [208] or other stimuli related that can guide the students to think and choose sensibly. The teacher is allowed to modify the information in box [218] generated in the teacher workstation [10] if appropriate. The “Play” button [206] is disabled before the teacher enters the answer collected from the student. Should the teacher choose to disclose the correct answer to the students who have failed in several attempts, he can then click the button “Play and Show”[212] to display the answer [210] on the student display [12], he can also trigger extra material or text in other language [297] to display on [298] so as to make the students understand the meaning of a word more easily.

In FIG. 5d. The teacher may review the teaching notes and stimuli of other teachers or to input his own teaching notes or stimuli in box [221a] before class. The teacher may enter his teaching notes or stimuli to be shown on the student display [12] by clicking the Save button [260]. The teacher may authorize the sharing of his teaching notes or stimuli with other teachers by clicking the Share button [262]. Further, a box [222] is provided for displaying and selecting the examples provided by other students and a box [224] is provided for entering the instructions for the students, for example, to do homework assignment that the teacher can also share with other teachers by clicking Share button [333].

### Multi-Lingual Display

The teacher may select the language of the student display [12] according to the need of the students stored in the student's profile by selecting a language in box [219] on FIG. 5a. By way of example, Chinese is used as the language of the student display [12], which also means that the student concerned would like to use Chinese as a plurality of extra languages to relate the subject matter easily, so that it is easier for him to understand the meaning of it.

There may be a mix of students from different countries in the class. Each student may prefer to have the student display [12] in his own language. In another preferred embodiment as shown in FIG. 5e, Distant Learning Screen, each teacher in a remote class or student learning from home, is provided with his own student display [12] including an input device, for example a workstation. The teacher or student may reset the selected language using pull down list [225] on his workstation in case he wants to choose to learn a second language as he learns English along.

Details regarding students taking part in the guided teaching and learning will be stored in the system using a user profile which includes the extra language translation the relevant student will like to use as extra material [600] on FIG. 5e used to help the student to learn more easily. The student can re-select his choice of language on his student display using pull down list [500] on 5e.

### Editing Materials

In this preferred embodiment, the teacher may easily edit the teaching materials, such as the question, the supplemental information and even the teaching notes or stimuli before class. As illustrated in FIG. 2, in step [301], the teacher may retrieve the teaching materials for editing. The teacher may edit the questions or prepare his own teaching notes on a page as illustrated in FIG. 5d. The teacher may edit the question in box [250] and click button “Edit base note” [252] to save the amendment. The teacher may also edit the supplemental information in box [254] and click button “Edit base note” [256] to save the amendment. The teacher may prepare the teaching notes or stimuli in box [258] and save the same by clicking Save button [260]. The teacher may further authorize the sharing of his teaching notes or stimuli with other teachers by clicking the Share button [262]. He may choose the level of difficulty of the teaching notes by clicking the level button [293] on 5d and [133] on 4d to make it easier for him to get to the type of teacher notes or stimuli most suitable for his own students.

### Networking

As illustrated in FIG. 6, the teacher workstation [10] and the student displays [12] are connected to the central processing unit [14], which may be, for example, a personal computer or a sever of the school. The server of the school may be connected to other computers [16], for example, in a student computer laboratory, or in the teacher office. The teachers and the students may also use their own computers [18] at home to access the central processing unit [14] via the Internet. There are two ways of implementation, Method (1) and Method (2). The central processing unit [14] of a school may be connected with the central processing unit [14] of another school to share the teaching materials. A global server [20] may contain the most updated software patch and teaching materials. The central processing units [14] may be connected to the global server [20] for regular downloading of the updated software patch and teaching materials.

### Method (1)—Computer Aided Method for Teaching and Learning in Class on LAN (RTN)

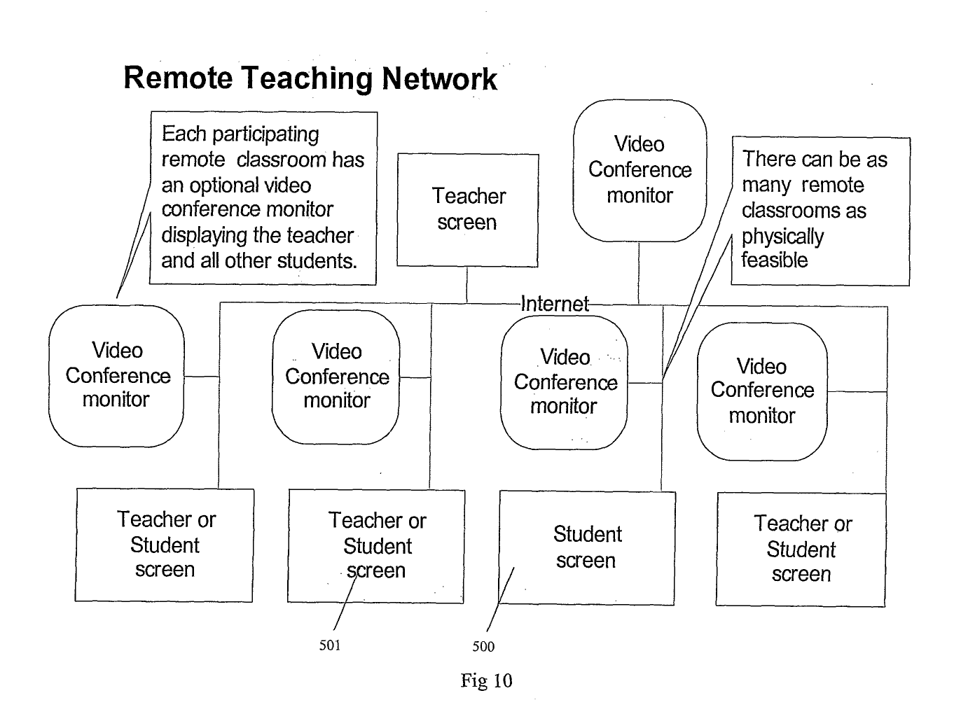

Each student either has a workstation, or shares a common display with the class using a projector. The teacher teaches using the same guided teaching method. The teacher screen will be similar to, for example, FIGS. 4a and 5a. The student screen will be similar to, for example, FIGS. 4b and 4c as well as 5b and 5c. The student(s) also has an optional conference device (FIG. 10) showing the teacher and all the participating students.

### Method (2)—Computer Aided Method for Teaching and Learning in Class on WAN Using the Concept of Cascade Remote Teaching Network (CRTN)

Each Remote Teaching Network can support up to as many students as physically feasible in a remote classroom or training venue. In the event that there are more students than the venue can accommodate, new RTN groups can be created.

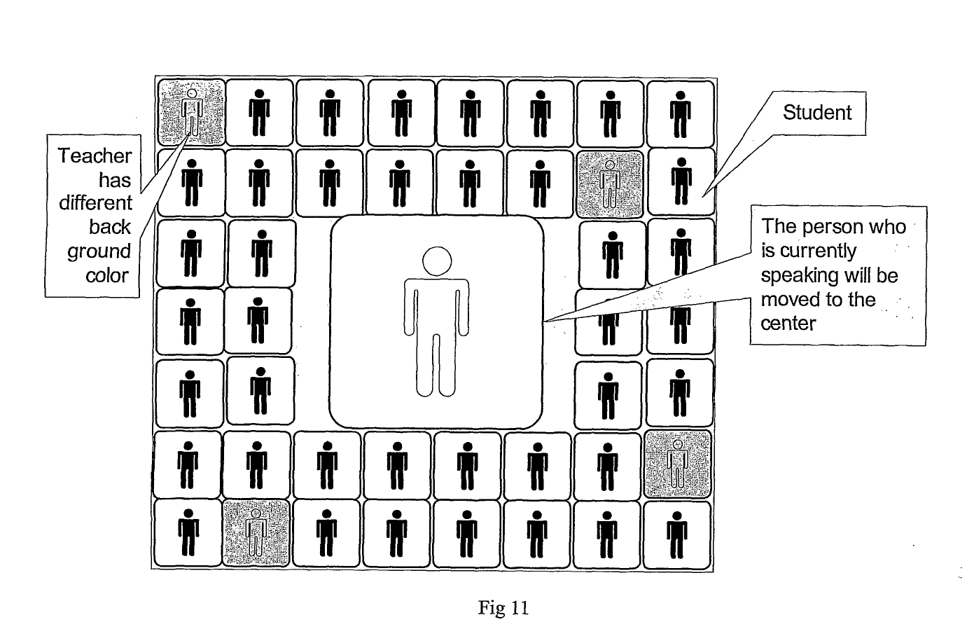

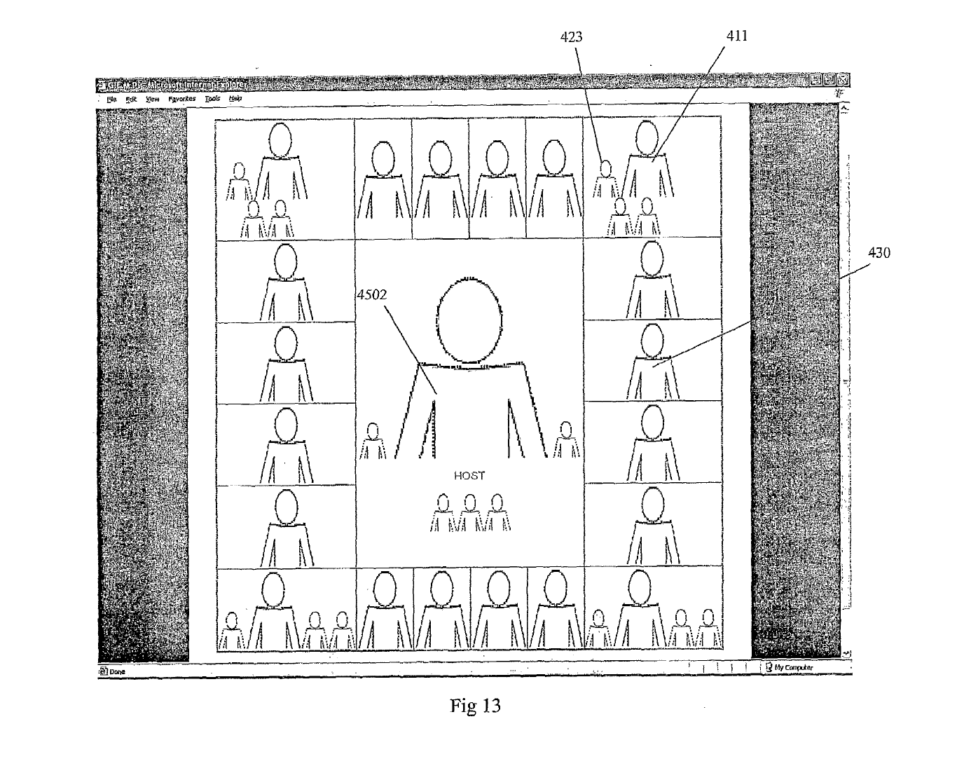

These new RTN groups can be cascaded to the main RTN network in a pyramid structure (FIG. 11). The head teacher interacts with the RTN group teachers or student learning individually from home via the Video Conference Monitor. Each RTN group teacher interacts with his/her group of students similar to RTN in Method (1). The CRTN group teachers act as relays of the head teacher as well as other guest teachers [430] in FIG. 13 to present the teaching materials to the students in his own locale.

While the communication network is based on Internet, the connectivity for each student to the network may include DSL, cable modem, T1, satellite, wireless or whatever means available at the geographic locale of the student.

### Video Conference Monitor

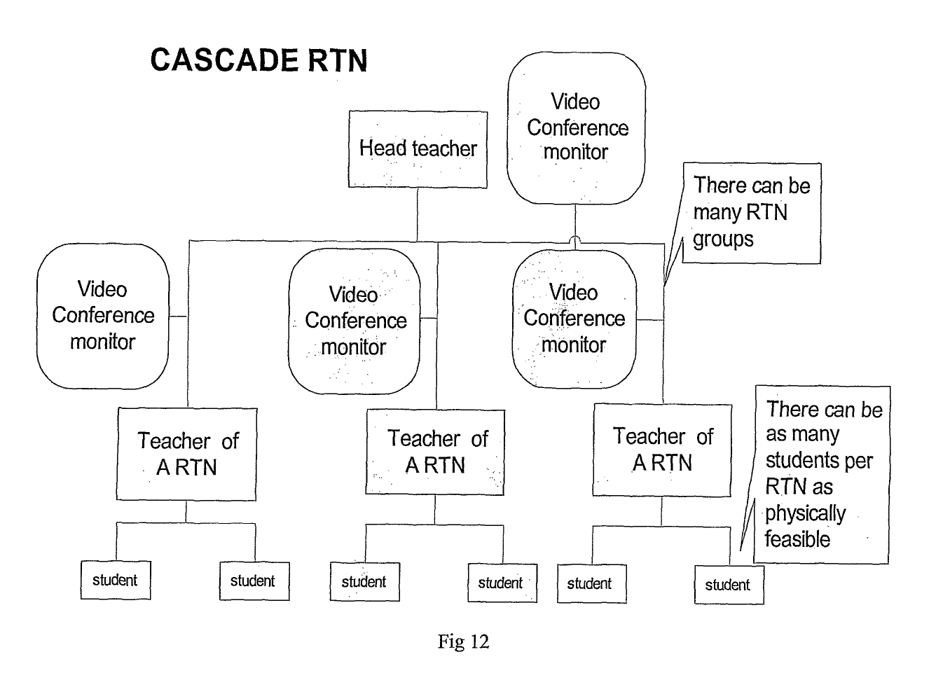

The key to a successful remote learning experience is the additional communication device—All the remote participating venues are equipped with communication device(s), for example, an extra computer (Video Conference Monitor) connecting to the internet. Upon a successful login to the system, the VCM automatically broadcast communication signals between the head teacher, guest teachers and all the participating venues. [FIGS. 10, 11, 12, and 13] joining the guided teaching and learning process.

### Individual Practice Session

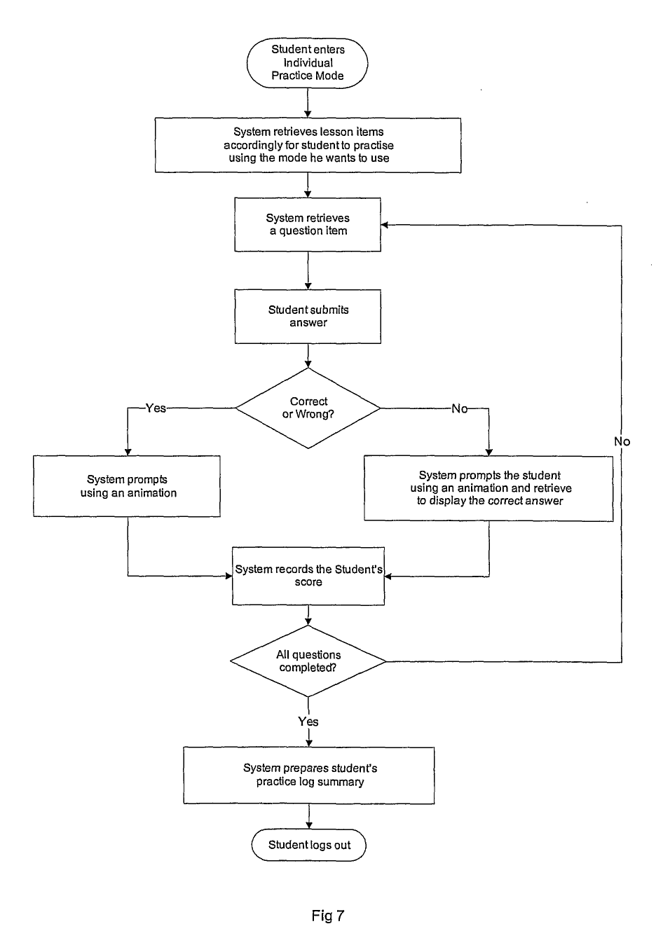

In addition to classroom teaching, the students may be requested to do homework assignment by taking individual practice session so as to enhance teaching and learning effect. In an individual practice sessions, by way of example as illustrated in FIG. 7, each student is given multiple choice questions related to the teaching materials. The students may access the questions in a computer laboratory in school or at home via the Internet.

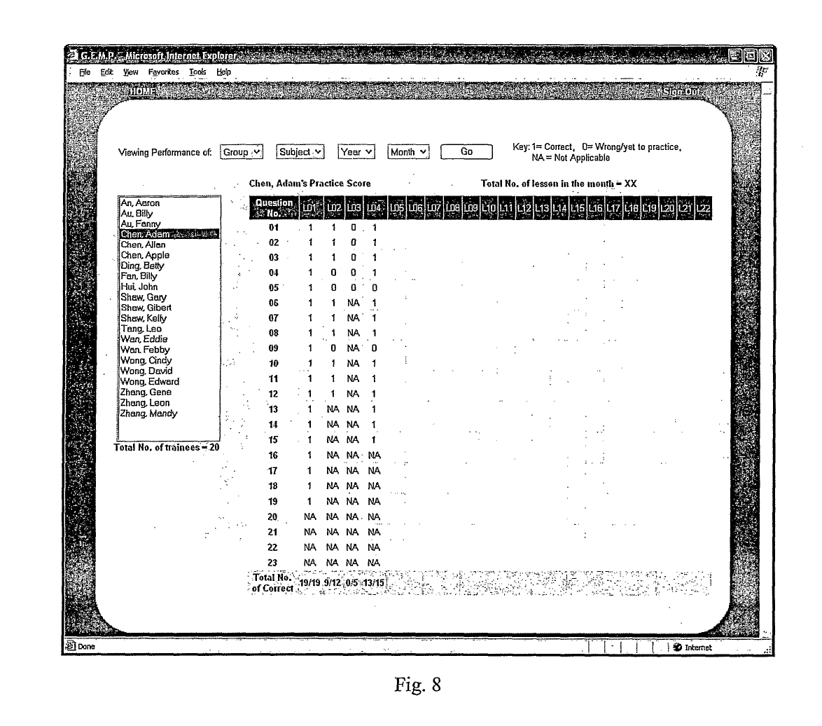

As illustrated in FIG. 8, the scores of the students are recorded by the central processing unit [14] in FIG. 6. By way of example, the student receives 1 score for each correct answer. The average score of all the students in the class therefore serves as an indicator on how familiar the class is with the teaching materials.

### Adaptive Teaching

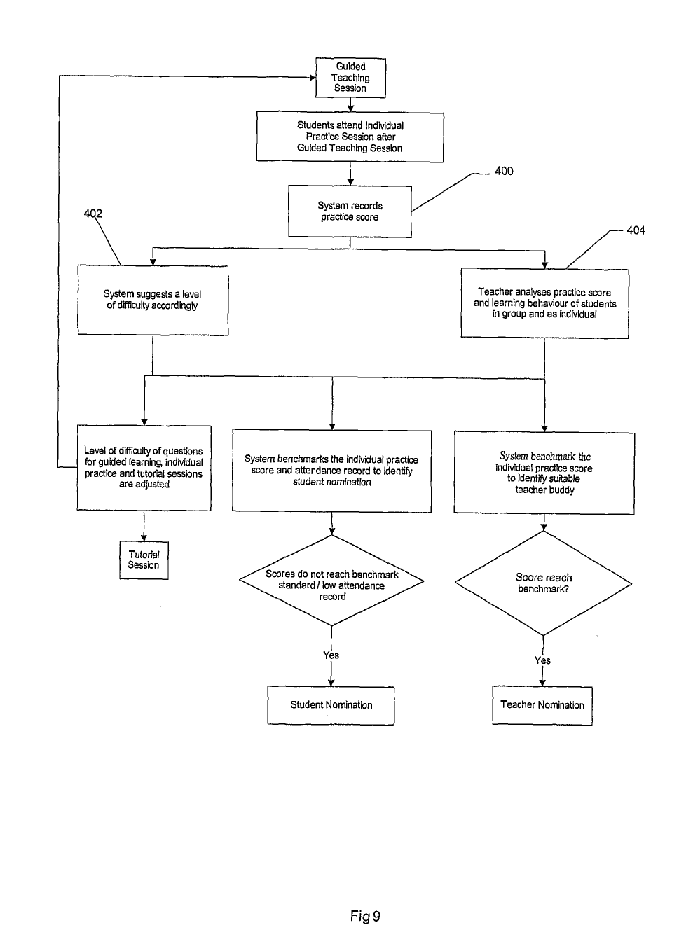

In a preferred embodiment as illustrated in FIG. 9, in step [400], the central processor unit [14] records the scores of the students in attending individual practice sessions. The central processor unit [14] then suggests the level of difficulty to be adopted for the guided teaching session, the individual practice session and the tutorial session (which will be further described below) in step [402], according to a pre-determined table matching the average score to the level of difficulty. The teacher may re-adjust the level of difficulty using [273] as shown in FIG. 4a and [230] as shown in FIG. 5a.

By way of example, in providing fill-in-the-blank questions as illustrated in FIG. 5b, the level of difficulty in providing fill-in-the-blank questions in a guided teaching session may be formulated by increasing or reducing the number of answers provided in box [208]. The more answers available to the students for selection, the more words the students need to know of the meaning before they can get at the right answer. As such, the level of difficulty increases with the number of answers for selection. The system can automatically generate the number of answers for selection according to the average score of the students in the individual practice session. The teacher may further adjust the number of answers if necessary according to the response of the students in class by using the pull down list [230] and [273].

### Tutorial Session

Some students may be required to take extra tutorial session to be conducted by the more advanced student in the class. The advanced student may take the role of the teacher and host a guided teaching session for his classmates using the present invention. The students who need to take the extra tutorial session may be those who skip the class or those who score low in the individual practice session. In another preferred embodiment, the central processing unit [14] may assign the students to conduct or to take the extra tutorial session according to the attendance record of the students and their score recorded in the individual practice session. The teacher may preset a practice score and an attendance level to be the benchmark for a student to be qualified to be the teacher in the tutorial session or to be required to take the tutorial session. The central processing unit [14] may match the score of the students in the individual practice session and the attendance record to the benchmark score and attendance level to suggest to the teacher the students who may qualify as a teacher in the tutorial session or who may be required to take the tutorial session. The teacher may also assign students to the tutorial session according to his own observation. In addition, the system can automatically structure the appropriate teaching content based on the participating students' scores and behavior.

### Saving Key Data

The central processing unit [14] will save the key data in the course of the guided teaching session, such as, the time required for the students to correctly answer a question, the number of times the teacher gives additional information on the student display for the students to select the correct answer and the number of wrong answers made by the students before reaching the correct answer. Such data may be used to review the course and to design better teaching materials, such as the questions, answers and additional information, to make teaching more effective.

### Database Structure

The following databases are used as part of the method and system of the present invention.

TABLE 1
Login Table

| Name | Description |
|---|---|
| LogInID | Unique ID for login |
| UserName | User Name for login |
| Password | Password |
| UserType | Type of users (Teacher/Admin/Students . . . etc) |

Table 1 holds the information for login. When a user login as illustrated in FIG. 1, he will select the user type and input his username and password. The system will then obtain the login ID from the Login Table and check whether the user is authorized to login. If the login is successful, the system will load the corresponding screen according to the user type. The system will at the same time retrieve the component for video conferencing wherever necessary to support remote teaching and learning interactively.

TABLE 2
Lessons Table

| Name | Description |
|---|---|
| LessonID | Unique ID for lesson |
| ModeID | Unique ID for teaching mode |
| ClassID | Unique ID for class |
| Level Of Difficulty | Level of difficulty |

Each lesson contains the teaching materials of the guided teaching system or the tutorial session, for example, the questions, the answers for selection, the additional information in various styles and stimuli, such as text, sound, voice, audio, graphics, pictures, photographs, animation, comics, or video. Table 2 holds a list of the Lesson ID.

After the teacher has input the required information and the lesson number in FIG. 2, the system will select the relevant Lesson ID from the Lessons Table and load the corresponding teaching materials to the teacher workstation [10] and the student display [12] according to the level of difficulty & the teaching mode applicable, which are determined by the system automatically through analysis of student performance and learning behavior.

TABLE 3
Mode Table

| Name | Description |
|---|---|
| ModeID | Unique ID for teaching mode |
| Name | Name of teaching mode |
| Description | Description of teaching mode |

Table 3 stores a list of the teaching mode. This table relates the teaching mode such as FIB, MPC, TOF and LRW and the description of the teaching mode to the Mode ID.

TABLE 4
LessonItemID Table

| Name | Description |
|---|---|
| LessonItemID | Unique ID for lesson Item |
| LessonID | Unique ID for lesson |

Each Lesson Item contains the teaching materials of each question. Table 4 contains the Lesson Item ID and the Lesson ID. After selecting a Lesson by the teacher, the system will select the relevant Lesson Item ID from the LessonItemID Table and load the corresponding teaching materials to the teacher workstation [10] and the student display [12] according to the Lesson Item ID.

TABLE 5
Phrase Table

| Name | Description |
|---|---|
| Phrase ID | Unique ID for the phrase |
| Phrase | The question phrase |
| Audio | Audio file of the phrase |
| Definition | Definition of the phrase |
| DefinitionAudio | Audio file of the definition of the phrase |
| Example | Example of the phrase |
| ExampleAudio | Audio file of the example of the phrase |

Table 5 contains phrases to be listed in box [112A] on teacher workstation [10] and box [112B] on student display [12] as well as examples of application [110] reflected on teacher workstation [10] which are to be displayed one by one [114B] on the student display [12]. Each example of application can be combined with the relevant idiomatic phrase, which is the lesson item to be taught, from [112] on student display [12] to form a meaningful statement [126]. There is also a list of definitions to illustrate the meaning of the idiomatic phrases. Each phrase is loaded according to the phrase ID.

TABLE 6
Vocabulary Table

| Name | Description |
|---|---|
| VocabID | Unique ID for vocabulary |
| Vocab | Vocabulary |
| Definition | Definition of vocabulary |
| DefinitionAudio | Definition of vocabulary in audio format |
| Example | Example of the application of the vocabulary |
| ExampleAudio | Audio file of the example of the application |
| Answer | Answer of the example |
| Extra Language Translation | Meaning of the vocabulary in another |
| | language |

Table 6 contains the vocabulary, which may be the answers for selection in a question. The vocabulary is to be combined with the definition of vocabulary, extra language translations and the data from other tables such as the digital file etc. to form a complete question set. The audio recording of the pronunciation of the vocabulary, its example of the application, audio of the example of the application, and the answer of the example and extra language translation are also included in this table.

TABLE 7
Digital File Table

| Name | Description |
|---|---|
| DigitalFileID | Unique ID for digital file |
| Type | Type of the digital file |
| FilePath | Retrieval path of the digital file |
| Description | Description related to the digital file |

Table 7 contains the ID for identifying the digital file related to each question. The digital file combines the data from other tables, such as the Phrase and the vocabulary, which may be the answers for selection, to form a complete question. This table also contains the type, the retrieval path and the description of the digital file.

TABLE 8
Classes Table

| Name | Description |
|---|---|
| ClassID | Unique ID for class |
| SubjectID | Unique ID for subject |
| ClassName | Name of class |
| Term | Term number |
| SchoolYear | School Year |

Table 8 contains the information of each class. The system may retrieve the name of the class, subject to be taught, the term, the school year and other information of each class by the Class ID.

TABLE 9
Student Table

| Name | Description |
|---|---|
| StudentID | Unique ID for student |
| ClassName | Name of class |
| PersonalID | Personal ID for student |
| FirstName | First name of student |
| MiddleName | Middle name of student |
| LastName | Last name of student |
| ExtraLanguage | The type of extra language preferred |

Table 9 contains the information of the students. The system may retrieve the information of the student, such as, the name of class, the student personal ID number, the first name, middle name and last name and the preferred extra language of the student by the Student ID. The additional language that used in translating the main object of learning e.g. vocabulary and phrasal verb, of the student display for selection may be set according to the nationality or personal profile of the student.

TABLE 10
Student Test Summary Log Table for the Individual Practice Session

| Name | Description |
|---|---|
| SummaryLogID | Unique ID for the Student Test Summary Log |
| StudentID | Unique ID for student |
| Score | Score of the Test |
| Remarks | Remark for the Test Summary Log |
| Correct | Number of correctly answered questions in a test |
| Wrong | Number of wrongly answered questions in a test |

Table 10 contains the students' test results in the Individual Practice Sessions. The table contains the score, the number of correctly and wrongly answered questions, and the remarks of the test. The score will be referred to in nominating the level of difficulty of questions for adaptive teaching, and in selecting the students to participate in the Tutorial Session. The teacher uses the data in combination of his in-class experience to dynamically re-adjust the level of difficulty of questions. The test results may be retrieved by the Student ID.

TABLE 11
Teacher Table

| Name | Description |
|---|---|
| Teacher ID | Unique ID for teacher |
| PersonalID | Personal ID for teacher |
| FirstName | First name of teacher |
| MiddleName | Middle name of teacher |
| LastName | Last name of teacher |
| Employment Date | Date of employment |

Table 11 contains the information of the teachers. The system may retrieve the information of the teachers, such as, the personal ID number, the first name, middle name and last name of the teacher, as well as the date the teacher was employed to teach by the Teacher ID.

TABLE 12
Teaching Notes Table

| Name | Description |
|---|---|
| NoteID | Unique ID for the teaching notes |
| ContentType | Type of teaching content of the teaching notes |
| Content ID | Unique ID of the ContentType |
| TeacherID | Unique ID of the teacher to identify the author |
| Date | The creation date of the teaching notes |
| UsageCount | Number of times the teaching notes was used in a lesson |
| Note | Content of the teaching notes |
| Note Level | Level of difficulty or grade level of the Teaching notes |

Table 12 contains the information of the teaching notes. The system may retrieve the content of the teaching notes, content type, level of difficulty, author, creation date and usage count by the NoteID. The Date and UsageCount keep track of the number of times the teaching notes have been selected to show to the students, and the teaching notes below a predetermined selection rate in a period of time will be automatically deleted.

TABLE 13
Class Memo Table

| Name | Description |
|---|---|
| ClassMemoID | Unique ID for the class memo |
| LessonID | Unique ID of the Lesson |
| TeacherID | Unique ID of the teacher to identify the author |
| Date | The creation date of the class memo |
| Memo | Content of the class memo |

Table 13 contains the information of the class memo. The system may retrieve the content of the class memo, its date of creation, lesson and author by ClassMemoID.

TABLE 14
Student Memo Table

| Name | Description |
|---|---|
| StudentMemoID | Unique ID for the student memo |
| LessonID | Unique ID of the Lesson |
| StudentID | Unique ID of the student to identify the author |
| Date | The creation date of the student memo |
| Memo | Content of the Student memo |

Table 14 contains the information of the student memo. The system may retrieve the content of the student memo, its date of creation, lesson and author by StudentMemoID.

TABLE 15
ModeLevel Table

| Name | Description |
|---|---|
| ModelLevelID | Unique ID for the ModeLevel |
| Level | Level of difficulty of the teaching mode |
| Description | Description on the content of the teaching mode |

Table 15 contains the information of the level of difficulty of the teaching mode. The system may retrieve level of difficulty of the teaching mode and its related content by ModeLevelID.

There are also databases containing other information, for example, the instructions to the students, the examples from the students to be used in quiz or test, the common error made by the students for teaching purpose and future reference, and the object of learning (e.g. vocabulary and phrasal verb) in other languages, which are used in the guided teaching session as described in the disclosed embodiments.

In addition to be used in class teaching, the present invention is also applicable in one-to-one teaching and long distance learning via the Internet. The present invention is not limited to teaching in school, but is also applicable to training in various aspects.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A computer-aided method for guided teaching and learning between a teacher and at least one student having at least one teacher workstation, at least one student display, and at least one central processing unit, and at least one optional video conference system, comprising the steps of:
(a) presenting a question that is the subject item to the student at said student display;
(b) receiving answer from the teacher at said teacher workstation, wherein said answer is received by the teacher from the student or students in class;
(c) sharing the answer submitted on said student display;
(d) determining whether said answer is correct;
(e) presenting feedback to said answer at said student display;
(f) receiving input from the teacher at said teacher workstation for the teacher to give further information related to said question on said student display;
(g) presenting information sequentially and structurally using a plurality of styles and stimuli corresponding to said input from teacher or student on said student display;
wherein said central processing unit is connected to said teacher workstation(s) and said student, such that the teacher provides guidance to the student(s) on said student display in a guided teaching session.

2. The computer-aided method as recited in claim 1, wherein said plurality of styles and stimuli comprises: text, sound, voice, audio, graphics, pictures, photographs, animation, comics and video.

3. The computer-aided method as recited in claim 1, wherein said question comprises a plurality of answers for selection.

4. The computer-aided method as recited in claim 1, further comprises the step of receiving input of notes that may be a plurality of styles and stimuli comprising: text, sound, voice, audio, graphics, pictures, photographs, animation, comics and video from the teacher at said teacher workstation.

5. The computer-aided method as recited in claim 4, further comprises the step of presenting said notes from the teacher at said teacher workstation on said student display.

6. The computer-aided method as recited in claim 4, further comprises the step of receiving an instruction from the teacher on the authorization for presenting said notes at said student display and controlling the presenting of said notes according to said instruction.

7. The computer-aided method as recited in claim 4, further comprises the step of storing said teacher notes that may be a plurality of styles and stimuli comprising: text, sound, voice, audio, graphics, pictures, photographs, animation, comics and video in said central processing unit.

8. The computer-aided method as recited in claim 7, wherein said notes are shared by said teacher workstation and said student display.

9. The computer-aided method as recited in claim 4, further comprises the step of receiving an instruction from the teacher on the authorization for sharing said notes by said teacher workstations and controlling the sharing of said notes according to said instruction.

10. The computer-aided method as recited in claim 7, wherein a level indicator is assigned to said notes for identifying the level of students applicable to said notes during retrieval of said notes.

11. The computer-aided method as recited in claim 2, wherein the student is engaged in individual practice session and the performance of the student in said individual practice session is recorded by said central processing unit.

12. The computer-aided method as recited in claim 11, wherein said central processing unit formulates said question according to an analysis of said performance.

13. The computer-aided method as recited in claim 11, wherein said central processing unit stores the attendance record of the student in said guided teaching session.

14. The computer-aided method as recited in claim 13, wherein at least one student is-selected by said central processing unit to engage in an extra tutorial session with teaching material structured by the system according to said attendance record and said performance, wherein at least one of said students is selected by the system to take the role of a teacher in said tutorial session.

15. The computer-aided method as recited in claim 1, wherein said central processing unit records key data for future revision of said question that is the subject matter of the teaching content, and said information, comprising at least one of:
the time between presenting said question and receiving said answer being correct;
the number of said input from the teacher between presenting said question and receiving said answer being correct; and
the number of said answers received from the teacher for each said question.

16. The computer-aided method as recited in claim 1, wherein said question or subject matter can be edited by the teacher.

17. The computer-aided method as recited in claim 1, wherein said information can be edited by the teacher.

18. The computer-aided method as recited in claim 4, wherein said notes comprises at least one of:
idea from the teacher related to said question,
illustrative example from the teacher related to said question,
idea from the student related to said question,
illustrative example from the student related to said question, and
instruction from the teacher to the student.

19. The computer-aided method as recited in claim 1, wherein one of a plurality of languages can be selected to be used on said student display according to the need of the student or group of students as stored in the students' personal profile(s).

20. The computer-aided method as recited in claim 19, further comprises at least one student input device for receiving from the student the selection of language to be used on said student display.

21. A computer-aided system for guided teaching and learning between a teacher and at least one student comprising:
a central processing unit, having memory means, for storing questions to be presented to said student;
at least one student display associated with said central processing unit for presenting said question to the student;
at least one teacher workstation associated with said central processing unit, having input means for receiving input from the teacher to give further information related to said question and for receiving answer from the teacher, wherein said answer is received by the teacher from the student;
wherein said central processing unit can be connected to said teacher workstation(s) and said student display locally on LAN to be supported by an optional conference device;
a wherein said system can be used in combination of an optional communication system using the concept of cascade remote teaching network, such that the teacher provides guidance to the student(s) on said student display in a guided teaching session remotely on WAN.
communication means between said central processing unit and said teacher workstation and between said central processing unit and said student display, and between said optional communication system;
wherein said central processing unit having processor means for determining whether said answer is correct and said student display present feedback to said answer; such that the teacher provides guidance to the student on said student display;

22. The computer-aided system as recited in claim 21, wherein said input may be a plurality of styles and stimuli comprises: text, sound, voice, audio, graphics, pictures, photographs, animation, comics and video.

23. The computer-aided system as recited in claim 21, wherein said input means receive input of notes from the teacher.

24. The computer-aided system as recited in claim 23, wherein said student display presents said notes to the student.

25. The computer-aided system as recited in claim 23, wherein said central processing unit stores said notes.

26. The computer-aided system as recited in claim 25, wherein a level indicator is assigned to said notes for identifying the level of the students applicable to said notes during retrieval of said notes.

27. The computer-aided system as recited in claim 25, wherein said notes are shared by said teaching workstations.

28. The computer-aided system as recited in claim 23, wherein said input means receive an instruction from the teacher on the authorization for presenting said notes on said student display; said central processing unit controls the presenting of said notes according to said instruction.

29. The computer-aided system as recited in claim 23, wherein said input means receive an instruction from the teacher on the authorization for sharing said notes by said teacher workstations; said central processing unit controls the sharing of said notes according to said instruction.

30. The computer-aided system as recited in claim 11, wherein said central processing unit records the performance of the student engaged in individual practice session.

31. The computer-aided system as recited in claim 30, wherein said central processing unit formulates said question according to an analysis of said performance.

32. The computer-aided system as recited in claim 30, wherein said central processing unit stores the attendance record of the student in said guided teaching session.

33. The computer-aided system as recited in claim 32, wherein said central processing unit selects at least one student to engage in an extra tutorial session according to said attendance record and said performance, wherein one of said students taking the role of a teacher in said tutorial session.

34. The computer-aided method as recited in claim 21, wherein one of a plurality of languages can be selected to be used on said student display.

35. The computer-aided method as recited in claim 34, further comprises at least one student input device for receiving from the student the selection of language to be used on said student display.

36. The computer-aided method as recited in claim 23, wherein said notes comprises at least one of:
idea from the teacher related to said question,
illustrative example from the teacher related to said question,
idea from the student related to said question,
illustrative example from the student related to said question, and
instruction from the teacher to the student.

37. The computer-aided method as recited in claim 12, wherein said central processing unit, allows the teacher to re-formulate the said question;

38. The computer-aided system as recited in claim 33, wherein said central processing unit formulates the said question or subject matter in the extra tutorial session based on the score and attendance record of the students in the individual practice sessions, who are nominated to take such extra tutorial session.

39. The computer-aided method as recited in claim 9, wherein said central processing unit processes the said notes to make them more easily for the teachers to access the notes most suitable for their student(s).
